(19) United States
(12) Patent Application Publication
(10) Pub. No.: US 2002/0125271 A1
(43) Pub. Date: Sep. 12, 2002

(54) Method of dispensing surgical lubricant

(76) Inventor: Scott Zeitlin, Los Angeles, CA (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/804,410

(22) Filed: Mar. 12, 2001

(51) Int. Cl. B67B 7/00; G01F 11/00

(52) U.S. Cl. 222/181.3; 222/1; 222/82; 222/321.7; 222/380

(57) ABSTRACT

Disclosed is a method for dispensing a lubricant and, more particularly, a surgical lubricant, from a mechanical dispenser. The method includes a health care worker positioning a hand or other receiving object near an outlet of a mechanical dispenser configured to dispense a surgical lubricant, then receiving the lubricant from the dispenser through the outlet onto the hand or receiving object.

### BACKGROUND OF THE INVENTION

1. Field of the Invention

The present invention relates to methods of using mechanical dispensers for dispensing liquids, and more particularly, surgical lubricants, onto a hand.

2. Description of the Related Art

Medical personnel use surgical lubricants, such as K-Y Jelly™ and Surgilube™, for a variety of medical procedures. The current method of dispensing a surgical lubricant is via a squeeze tube, which contains multiple units, or an individual packet, which contains a single unit. There are several problems associated with the current method of dispensing surgical lubricants. For example, it is often messy and cumbersome for a medical practitioner to squeeze a small amount of lubricant out of a tube for use in a medical procedure. Opening an individual packet of lubricant can be similarly messy and cumbersome, and occasionally a packet will cut the medical practitioner's protective glove. This situation is dangerous and unsanitary for both the practitioner and patient.

Furthermore, the current method of dispensing surgical lubricant is not cost-effective. A certain amount of surgical lubricant remaining in either a squeeze tube or an individual packet is wasted with each use. Dispensing surgical lubricants in this manner is also inconvenient because the tube or individual packet must be stocked and located prior to examining a patient. These additional preparations take time and diminish cost and time efficiency of a medical office.

Other types of products, such as hand lotion and soap, are delivered for use from containers by small hand-operated pumps, or pumps that operate via a foot pedal. Some of these pumps, such as those supplied with window cleaning compounds, utilize a dip tube extending below the pump apparatus to draw fluid up to the pump for its exit. Others employ a configuration wherein a fluid-containing reservoir is disposed above the pump apparatus. Dispensers of the latter variety are particularly well suited for use as wall mounted soap dispensers in washroom facilities. Since the container is positioned above the pump, location of the pump's outlet directly above a wash basin is facilitated.

Mechanical dispensers have been described in various publications, including the following U.S. patents, which are herein incorporated by reference in their entirety: U.S. Pat. No. 1,729,903 to T. J. Stephens, issued Oct. 1, 1929; U.S. Pat. No. 2,000,493 to J. C. Miller, issued May 7, 1935; U.S. Pat. No. 2,148,711 to A. C. Reeve, issued Feb. 28, 1939; U.S. Pat. No. 2,227,706 to M. G. Conner, issued Jan. 7, 1941; U.S. Pat. No. 3,337,096 to F. E. Brown, issued Aug. 22, 1967; U.S. Pat. No. 3,414,169 to D. F. Corsette, issued Dec. 3, 1968; U.S. Pat. No. 3,478,934 to A. M. Lindquist, issued Nov. 18, 1969; U.S. Pat. No. 3,844,452 to M. R. Blum, issued Oct. 29, 1974; U.S. Pat. No. 4,767,022 to D. Oldorf, issued Aug. 30, 1988; U.S. Pat. No. 5,163,581 to C. M. Lombardi, Jr., issued Nov. 17, 1992; U.S. Pat. No. 5,165,572 to C. P. Bath, issued Nov. 24, 1992; U.S. Pat. No. 5,294,020 to S. A. Kunz, issued Mar. 15, 1994; U.S. Pat. No. 6,012,613 to Y. C. Chen, issued Jan. 11, 2000; and, particularly by U.S. Pat. No. 3,952,918 to E. J. Poitras, et al., issued Apr. 27, 1976.

### SUMMARY OF THE INVENTION

Described herein are methods of obtaining lubricant, especially surgical lubricant, from a mechanical dispenser. The mechanical dispenser can be modified to contain a plastic bag, with or without a metallic coating that lines the inner surface of the bag, filled with lubricant. To obtain lubricant, a medical practitioner may press on the handle of a mechanical dispenser filled with lubricant and hold their hand or other receiving object near or under the outlet. In a further embodiment the mechanical dispenser may be mounted on a wall for increased convenience.

### BRIEF DESCRIPTION OF THE DRAWINGS

FIG. 1 is a cross-sectional elevation view of a preferred lubricant dispenser.

FIGS. 2 and 3 are cross-sectional plan and elevation views, respectively, of a clamp apparatus that can optionally be employed with the dispenser shown in FIG. 1.

FIG. 4 is a cross-sectional elevation view of an alternate fluid container apparatus.

FIG. 5 is an enlarged bottom view of a seal cup utilized with the dispenser of FIG. 4.

### DETAILED DESCRIPTION OF THE PREFERRED EMBODIMENT

Many surgical lubricants of various compositions are available for a variety of uses. Certain surgical lubricants, such as K-Y Jelly™, are aqueous, i.e., water-based and/or water soluble. Surgical lubricants can be used to moisturize dry tissue, to lubricate body orifices, and to aid in various medical procedures. The term “surgical lubricant,” as used herein, refers to any appropriate lubricant used in a health-care practice, such as those used by physicians, in or on a patient. Such use includes, for example, lubrication for gynecological, gastroenterological, or urological examinations.

Many different types of mechanical dispensers can be used to extrude lubricants, such as surgical lubricants, including the dispenser described in U.S. Pat. No. 3,952,918. Disclosed herein is one of the many different mechanical dispensers that can be used for extruding lubricant.

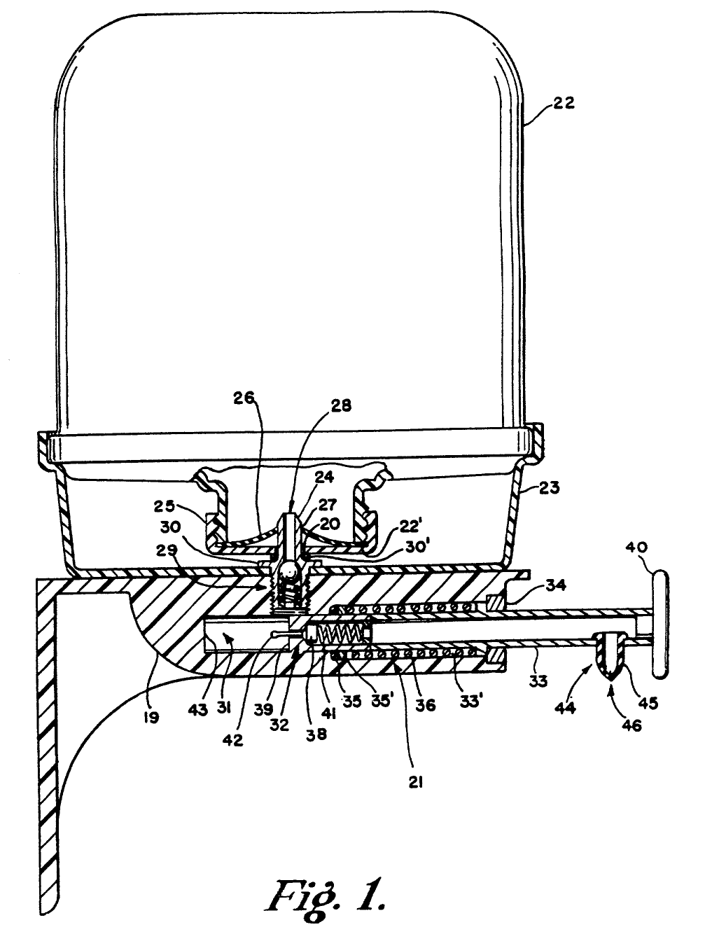

Referring first to FIG. 1 there is shown a hand operated pump 21 for dispensing small quantities of fluid from a container bottle 22. Supporting the bottle 22 is a support cup 23 mounted on a base member 19. With the bottle 22 in the operative position shown in FIG. 1 a puncture tube 24 threadedly retained by the base 19 passes through an aperture 20 in a bottle cap 25. A gasket seal 26 is seated between the inner surface of the bottle cap 25 and the top edge 22′ of the bottle 22 in the conventional manner. The cap 25 both retains the seal 26 and prevents inadvertent puncture thereof prior to the time of intended use. Preferably, the seal 26 is made of resilient material and remains in sealing engagement with an outer seal surface 27 of the puncture tube 24. In addition, the aperture 20 in the bottle cap 25 is sealed by an O-ring 30′ seated between the outer surface of the cap 25 and a shoulder 30 formed on the tube 24. Thus, all fluid flowing from the bottle 22 must pass through a passage 28 extending through the puncture tube 24.

Mounted in the tube 24 is a spring loaded check valve 29 that closes the passage 28. The valve 29 only permits the passage of fluid if the pressure within the bottle 22 exceeds the pressure in a cylindrical chamber 31 formed in a base 19 and communicating with the passage 28. One wall of the chamber 31 is formed by a spring loaded valve 32 that is bonded to the end of a hollow tubular piston 33 having an opposite end closed by a handle 40. Accommodating the piston 33 in the base 19 is a counter bore 33′ coaxial with the chamber 31. The piston 33 passes through a retaining ring 34 pressed into an accommodating recess in the base 19 and an inner O-ring 35 retained between a shoulder formed by the counter bore 33′ and a washer 35′. Extending between the washer 35′ and an annular boss 37 on the piston 33 is a spring 36 that urges the piston toward the right as viewed in FIG. 1. The valve 32 comprises a pressure responsive valve member 38 that opens when the pressure in the chamber exceeds, by a predetermined level, the pressure in the hollow piston 33. The opening pressure required is determined by a spring 41 that resists movement of the valve member 38. Further valve control, however, is provided by a pin 42 that extends from the valve member 38 beyond the end 39 of the valve body 32. As the piston 33 is moved inwardly, the pin 42 engages an end wall 43 of the chamber 31 and forces the valve 32 to open regardless of pressure in the chamber 31.

An outlet orifice 44 in the piston 33 is plugged by a pliable rubber cap 45 with a slit 46 in the lower surface thereof. The cap 45 acts as an outlet valve and opens to relieve pressure within the piston 33 caused by fluid flow thereinto through the valve 32. Air is allowed to enter the bottle 22 during use through a pin hole (not shown) punched through the bottom thereof.

To use the dispenser 21, a bottle 22 previously filled with a lubricant, for example, is inverted and placed in the operative position within the support 23. At that time the puncture tube 24 passes through the gasket seal 26. However, fluid flow into the chamber 31 is prevented by the check valve 29. The handle 40 and, accordingly, the piston 33 are then pressed toward the left as viewed in FIG. 1 compressing the air in the chamber 31. When the pin 42 strikes the wall 43 the valve member 38 opens and the pressure in the chamber 31 is relieved. As the handle 40 is allowed to return under the influence of the spring 36, a partial vacuum is created in the chamber 31. When the handle 40 nearly reaches the position shown in FIG. 1, the passage between the chamber 31 and the check valve 29 is opened, the low pressure in the chamber 31 allows the valve 29 to open and atmospheric pressure in the bottle 22 forces a measured amount of lubricant into the chamber 31. When the handle 40 is again pressed to the left, the resultant fluid pressure in the chamber 31 opens the pressure responsive valve member 38 and the moving surface 39 forces fluid through the valve 32 into the hollow piston 33. Each subsequent reciprocal movement of the handle 40 similarly induces first an emptying and then a filling of chamber 31. After several such actuations, the interior of the piston 33 is filled and further influx of fluid through the valve 32 produces a lubricant discharge out of the piston 33 through the outlet valve 45. When this operating condition is reached, each depression and release of the handle 40 causes a measured amount of lubricant to flow from the outlet valve 45.

During this pumping operation, the valve member 38 and the pin 42 function to prevent discharged lubricant from accumulating on the outer surface of the outlet valve 45. Consequently, a tidy appearance is more easily maintained and unwanted dripping from the valve 45 is prevented. These functions are provided by the pin 42 which induces a transient reverse pumping action at the completion of each positive pump stroke by the piston 33. As described above, contact between the pin 42 and the wall surface 43 maintains the valve member 38 open regardless of the pressure in the chamber 31. Thus, after each complete pump stroke, the valve member remains open during initial outward motion of the piston 33. The partial vacuum created during this period draws lubricant from the hollow piston into the chamber 31. This action continues only until the pin moves out of contact with the surface 43. Thus, at the completion of each pump stroke a metered quantity of lubricant is returned from the hollow piston 33 to the chamber 31 producing suction at the outlet slit 46 and thereby preventing the above-noted external accumulation of lubricant.

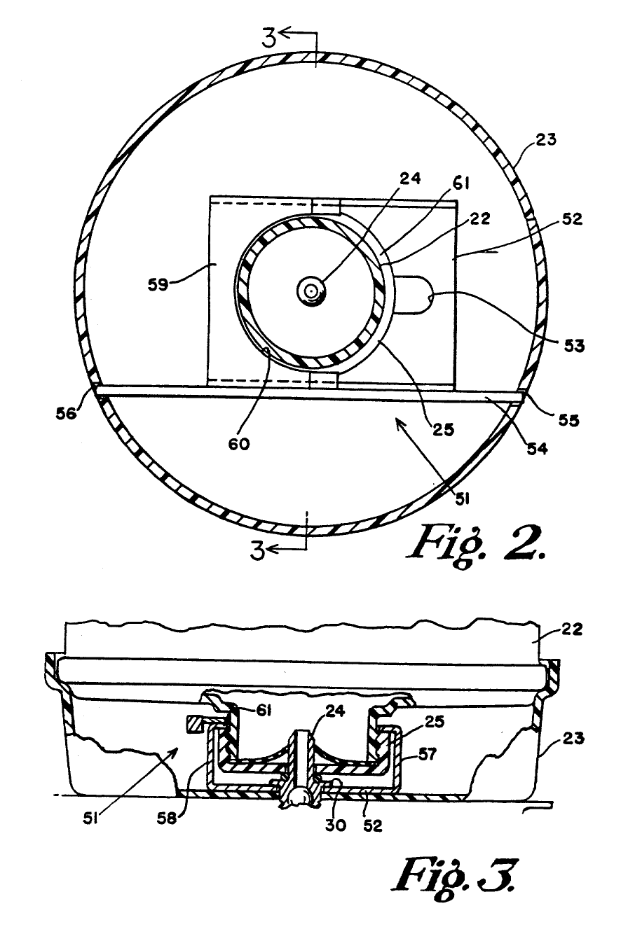

Referring now to FIGS. 2 and 3 there is shown an optional clamp apparatus 51 that can be utilized in conjunction with the subject dispenser. A plate 52 is retained between the shoulder 30 on the puncture tube 24 and the support cup 23. The puncture tube 24 passes through an elongated slot 53 in a plate 52 so as to allow sliding movement thereof. An elongated actuator rod 54 passes through two openings 55 and in the support cup 23. Vertical side walls 57 and 58, extending from the plate 52, terminate in a transverse support plate 59 with a U-shaped notch 60 therein. The U-shaped notch 60 surrounds and extends over the edge 61 on the bottle cap 25 as shown in FIGS. 2 and 3.

To remove the bottle 22, the actuator 54 is pressed to the left (as viewed in FIG. 2) by an external tool (not shown) that passes through the opening 55. Thus, the plate 52 moves to the left, and the bottle cap 25 is released. After a new bottle 22 has been located in place, the end of the actuator rod 54, protruding from the opening 56 is depressed until it is flush with the outer surface of the support cup 23. When that is done, the U-shaped plate 59 is again in the position shown in FIGS. 2 and 3 and the bottle cap 25 is securely retained. Furthermore, with the clamping mechanism 51 in that position, the actuator rod 55 is concealed within the cup 23 and can be moved into release position only by a tool fitting through the opening 55. Thus, the possibility of having the bottle 22 removed by unauthorized personnel is substantially reduced.

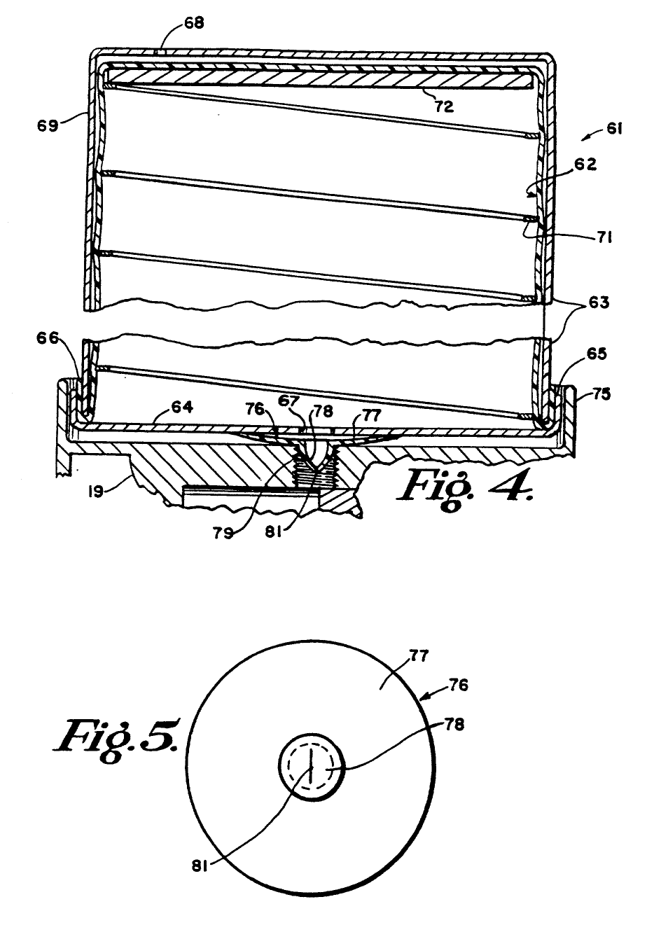

Referring now to FIG. 4 there is shown another container embodiment 61 mounted on the base member 19 shown in FIG. 1. Lubricant is contained by a flaccid bag 62 made, for example, of plastic or metal. Preferably the bag 62 is filled with a pliable substance such as lubricant. Enclosing the bag 62 is a cylindrical can 63 with a cover 64 having an annular skirt portion 65. A marginal portion 66 along an open end of the bag 62 is retained between the outer surface of the can 63 and the inner surface of the annular skirt portion 65. Centrally located in the cover 64 is a discharge opening 67 while opposite thereof is a vent opening 68 extending through a top wall 69 of the can 63. A reinforcing cylindrical coil member 71 is axially aligned with the opening 67 and contacts the inner surface of the bag 62. The coil member 71 made, for example, of plastic or metal is easily collapsible axially but is resistant to collapse radially and integrally with the bag 62. Also retained within the bag 62 is a circular disc 72 located directly adjacent the end of the bag opposite the discharge opening 67.

The can 63 is supported by the base 19 and is retained thereon by an annular, vertically extending rim 75. The remainder of the base member 19 is identical to that shown in FIG. 1 except that the check valve 29 is replaced in embodiment 61 by a cup member 76 shown also in FIG. 5 and formed, for example, of a suitable elastomeric material. The cup member 76 comprises a semispherically shaped seal portion 77 joined centrally with a hollow nozzle portion 78 that is press fitted into a threaded opening 79 in the base member 19. A slit 81 provides a discharge opening in a lower conically shaped portion of the nozzle 78.

During use of the embodiment 61, a lubricant filled bag 62 is inserted into the opened can 63 which is then closed by the cover 64 as shown in FIG. 4. As the can 63 is positioned on the base member 19, an air seal is formed around the opening 67 between the cover 64 and the semispherical seal portion 77. Manipulation of the pump 21 as described above in connection with FIG. 1 produces a vacuum pressure that draws lubricant through the discharge opening 67 and the slit 81 into the pump chamber 31 from which it can be dispensed. As the contents of the bag 62 are depleted, atmospheric pressure insured by the vent opening 68 causes collapse of the bag 62. Because of the coil member 71, however, this collapse progresses uniformly in a vertical direction toward the discharge opening 67 since horizontal collapse is prevented by the axial rigidity of the coil member 71. Consequently, no sidewall portion of the bag 62 is allowed to reach and thereby seal the discharge opening 67. In addition, the shield disc 72 prevents the end wall of the flexible bag 62 from reaching the opening 67. Thus, the opening 67 is maintained open to insure that the entire contents of the bag 62 are emptied.

The mechanical dispenser disclosed herein can be used by medical personnel to obtain lubricant. A medical practitioner may press on the handle 40 and position his or her hand under the outlet slit 46 to receive lubricant. Alternatively, a foot pedal may be used to release the lubricant from the dispenser. In a further embodiment, the medical practitioner may position any receiving object other than a hand under the dispenser, such as a bowl or a gauze. In some embodiments the mechanical dispenser may be mounted on a wall for increased convenience.

Dispensing lubricant from a mechanical dispenser has a number of advantages over the previous method of lubricant dispersal. For example, it is easier to obtain lubricant from the present invention than from a squeeze tube or an individual packet containing lubricant. To use the present invention, a medical practitioner merely presses on a handle and places his or her hand under an outlet slit from which lubricant is extruded. By contrast, to use a squeeze tube, the medical practitioner must remove the cap, squeeze a certain amount of lubricant out of the tube, and replace the cap. To use an individual packet, a medical practitioner must tear open the packet, squeeze lubricant out of the packet, and throw the empty packet away.

In addition, the present invention is safer than the previous methods of lubricant dispersal. Previous methods of lubricant dispersal, in particular obtaining lubricant from an individual unit packet, can lacerate a medical practitioner's protective glove. Laceration can increase risk of contamination of both the practitioner and patient. The present invention has a much reduced risk of glove laceration.

Furthermore, the present invention produces less waste than the previous methods of lubricant dispersal. It is difficult to accurately measure an amount of lubricant squeezed out of a tube, which can lead to overuse and wastage of lubricant. Generally, in both squeeze tube and individual unit packets, a certain amount of lubricant is lost in transferring the lubricant from the package to the medical practitioner. The present invention reduces waste and is therefore more cost-effective than the previous methods of lubricant dispersal.

Using the present invention is more time-efficient than previous methods of lubricant dispersal. Mounting the present invention in a convenient location can reduce preparation time before examining patients, thus freeing up a few extra moments that can be spent with a patient.

From the foregoing description, it will be appreciated that a novel approach for the application of a surgical lubricant to the hands or fingers has been disclosed. While aspects of the invention have been described with reference to specific embodiments, the description is illustrative and is not intended to limit the scope of the invention. Various modifications and applications of the invention may occur to those who are skilled in the art, without departing from the true spirit or scope of the invention. The breadth and scope of the invention should be defined only in accordance with the appended claims and their equivalents.

What is claimed is:

1. A method for dispensing a lubricant onto a receiving object comprising:
causing a mechanical dispenser to dispense said lubricant from within said dispenser to outside said dispenser;
positioning said receiving object near said dispenser; and
receiving said lubricant from said dispenser onto said receiving object.

2. The method of claim 1, wherein said receiving object is a hand.

3. The method of claim 2, wherein said hand is gloved.

4. The method of claim 1, wherein said mechanical dispenser is attached to a wall.

5. The method of claim 1, wherein said lubricant is a surgical lubricant.

6. A method for dispensing a lubricant comprising:
moving a handle of a mechanical dispenser, said dispenser being configured to dispense said lubricant, wherein said moving of said handle causes opening of a valve in said dispenser, said opening of said valve permitting efflux of said lubricant from within said dispenser to outside said dispenser through an outlet of said dispenser;
positioning a receiving object near said outlet of said dispenser; and
receiving said lubricant from said dispenser onto said receiving object after said lubricant flows through said outlet.

7. The method of claim 6, wherein said lubricant is a surgical lubricant.

8. The method of claim 6, wherein said mechanical dispenser is attached to a wall.

9. The method of claim 6, wherein said receiving object is a hand.

10. The method of claim 9, wherein said hand is gloved.
